(19) United States
(12) Patent Application Publication
(10) Pub. No.: US 2012/0222585 A1
(43) Pub. Date: Sep. 6, 2012

(54) SEQUENTIAL OXIDATION OF CARBON BLACK FOR INK-JET DISPERSION

(75) Inventors: Michael J. Eiseman, Swarthmore, PA (US); Harry Joseph Spinelli, Wilmington, DE (US); William F. Delgiorno, Aston, PA (US)

(73) Assignee: E.I. Du Pont de Nemours and Company, Wilmington, DE (US)

(21) Appl. No.: 13/508,756

(22) PCT Filed: Dec. 1, 2010
(86) PCT No.: PCT/US10/58494

§ 371 Date: May 9, 2012

Related U.S. Application Data
(60) Provisional application No. 61/265,460, filed on Dec. 1, 2009.

(51) Int. Cl. C09C 1/56

(52) U.S. Cl. 106/476; 106/478

(57) ABSTRACT

A process for preparing self-dispersing pigment dispersion for ink-jet application is provided in which a carbon black pigment is first oxidized in a gaseous phase and subsequently functionalized in an aqueous environment.

This application claims priority under 35 U.S.C. §119 from U.S. Provisional Application Ser. No. 61/265460, filed Dec. 1, 2009.

### BACKGROUND OF THE INVENTION

This invention relates to self-dispersing pigments and particularly to a process of making self-dispersing pigment dispersions.

Aqueous dispersions of pigments are widely used in inkjet printing. Because a pigment is typically not soluble in an aqueous vehicle, it is often required to use a dispersing agent, such as a polymeric dispersant or a surfactant, to produce a stable dispersion of the pigment in the aqueous vehicle.

Self-dispersing pigment dispersions do not require the use of dispersing agents. U.S. Pat. No. 2,439,442 discloses a process in which a carbon black pigment is exothermically reacted with an aqueous solution of sodium hypochlorite, or is subjected to electrolysis in a sodium chloride solution, or is suspended in a sodium hydroxide solution and treated with chlorine gas to alter the colloidal properties such that the carbon black will readily and spontaneously disperse in water. Inks made from these dispersions are said to be waterfast on newsprint.

U.S. Pat. No. 6,852,156 discloses a process of oxidizing carbon black using ozone in an aqueous environment. U.S. Pat. No. 3,023,118 discloses a process of oxidizing carbon black with dilute nitric acid to render it more readily dispersable. U.S. Pat. No. 3,279,935 discusses gas phase oxidation of a carbon black pigment in general, and particularly teaches a gas phase oxidation process in which a carbon black is treated with an oxygen containing gas admixed with a peroxide gas.

All of these treatment processes in the prior art to modify the surface of carbon black have one disadvantage or another. The gas phase oxidation can be very exothermic and thus poses a significant safety hazard. Also, it is difficult to adequately deagglomerate carbon black particles in the gas phase to the small sizes required for ink-jet application. If the deagglomeration is conducted in a subsequent liquid milling step, the resulting pigment dispersion readily reagglomerates. The liquid phase oxidation also requires the difficult process of creating a high concentration of hydrophobic pigment slurry in water to make the oxidation process more economical. However, high concentrations of pigment slurry have high viscosity and require expensive processing vessels to adequately mix the slury. A need exists for an easy-to-operate and low cost process for making self-dispersing pigments. The present invention satisfies this need by providing a sequential oxidation process that removes the aforementioned disadvantages of separate gas phase and liquid phase oxidation.

### SUMMARY OF THE INVENTION

An embodiment of the invention provides a process for making a self-dispersing pigment dispersion comprising the steps of:

(a) subjecting a carbon black pigment to oxidation in a gaseous environment to an acid value of greater than 0.1 mmol of acid per gram of pigment; and

(b) functionalizing the product of step (a) in an aqueous environment.

Another embodiment provides that step (b) introduces ligands containing at least one carboxylic functional group, said ligands are covalently attached to the pigment.

Another embodiment provides that step (b) comprises the steps of:

(i) mixing the product of step (a) with an inorganic base in an aqueous solution; and

(ii) oxidizing in an aqueous environment while simultaneously subjecting the pigment to at least one dispersive mixing operation.

Another embodiment provides that the carbon black pigment is present in an amount of up to 50% by weight.

Another embodiment provides that the carbon black pigment is present in an amount between 5% and 25% by weight.

Another embodiment provides that the inorganic base is selected from the group consisting of KOH, NaOH and LiOH.

Another embodiment provides that the average particle size after step (ii) is between 0.005 microns and 5 microns.

Another embodiment provides that the average particle size after step (ii) is between 0.01 microns and 0.3 microns.

Another embodiment provides that the gaseous environment in Step (a) comprises ozone.

Another embodiment provides that the ozone in the gaseous environment of Step (a) is 1% to 20% by weight of ozone gas in a carrier gas.

Another embodiment provides that the aqueous environment for step (ii) comprises an oxidant for functionalizing the pigment.

Another embodiment provides that the oxidant in the aqueous environment is selected from the group consisting of ozone, hypohalide salts, hydrogen peroxide, and metal salts of a permanganate.

Another embodiment provides that the oxidant in the aqueous environment is ozone.

Another embodiment provides that the pH of the aqueous environment for step (ii) is in the range of 6 to 9.

Yet Another embodiment provides that the process further comprises purifying the self-dispersing pigment dispersion.

### DETAILED DESCRIPTION

Unless otherwise stated or defined, all technical and scientific terms used herein have commonly understood meanings by one of ordinary skill in the art to which this invention pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “dispersion” means a two phase system where one phase consists of finely divided particles (often in the colloidal size range) distributed throughout a bulk substance, the particles being the dispersed or internal phase and the bulk substance being the continuous or external phase. The bulk system is often an aqueous system.

As used herein, the term “stable dispersion” means a particle dispersion where the particle size growth is less than 10% and no flocculation is developed after the dispersion is stored at 70° C. for at least a week.

As used herein, the term “pigment” means any substance usually in a powder form which imparts color to another substance or mixture. A carbon black is included in this definition.

As used herein, the term “HSD” means High Speed Dispersing.

As used herein, the term “D50” means the volume particle diameter of the 50^{th} percentile (median) of the distribution of particle sizes.

As used herein, the term “SDP” means a “self-dispersible” or “self-dispersing” pigment.

As used herein, the term “psi” means pound per square inch, a pressure unit.

As used herein, the term “cPs” means centipoise, a viscosity unit.

As used herein, the term “dyne/cm” means dyne per centimeter, a surface tension unit.

As used herein, Surfynol® 465 is a surfactant commercially available from Air Products (Allentown, Pa., U.S.A.).

As used herein, Proxel™ GXL is a Biocide commercially available from Avecia (Wilmington. Del., U.S.A.).

Unless otherwise noted, the above chemicals were obtained from Aldrich (Milwaukee Wis., U.S.A.) or other similar suppliers of laboratory chemicals.

The materials, methods, and examples herein are illustrative only except as explicitly stated, and are not intended to be limiting.

In addition, references in the singular may also include the plural (for example, “a” and “an” may refer to one, or one or more) unless the context specifically states otherwise.

In one embodiment, the present invention provides a process for making a self-dispersing pigment dispersion for inkjet application comprising the steps of:

(a) subjecting a carbon black pigment to oxidation in a gaseous environment to an acid value of greater than 0.1 mmols of acid per gram of pigment; and

(b) functionalizing the product of step (a) in an aqueous environment. In Step (a), a carbon black pigment is oxidized in a gaseous environment. Typically a carbon black is oxidized using ozone, or an oxygen-bearing gas admixed with gaseous peroxide, in an amount sufficient to oxidize the surface of the carbon black such as the method disclosed in U.S. Pat. No. 6,471,763. Gaseous oxidation of carbon black is known in the art. For a leading reference, see: U.S. Pat. No. 3,279,935. Various oxidation methods can be employed as long as they produce a carbon black having an acid value of greater than 0.1 mmol of acid per gram of pigment. Carbon black pigments having such acid values can be easily mixed into water at a low viscosity for Step (b). Low viscosity is advantageous because a distributive mixing process is more efficient when the viscosity of the mixture is low. Furthermore, a low viscosity mixture is less burdensome on pumps, pre-mix apparatus and dispersive mixing device than a higher viscosity mixture. Thus, less costly equipment can be used without sacrificing throughput, and the equipment can last longer, which results in an overall improvement in process efficiency. However, a carbon black after the initial dry oxidation Step (a) is not suitable to be used directly in an ink-jet ink because it does not posses the long term dispersion stability required for ink-jet application. Furthermore, the particle size of such carbon black is usually not small enough for ink-jet application.

In the present invention, Acid Value is expressed as milli-mole per gram (“mmole/g”) of pigment. To determine the Acid Value of a pigment after Step (a). 50 grams of water are added to 0.5 grams of the pigment followed by sufficient amount of an aqueous KOH (11.7 N) to bring the pH to at least 11.2. The resulting slurry is titrated under agitation with aqueous HCl (0.5 M) while the pH is monitored and recorded. The pH trace thus obtained has two inflection points with the first inflection point (typically near pH 8) representing the amount of acid required to neutralize the excess KOH in the solution, and the second inflection point (typically near pH 5) representing the amount of acid required to neutralize both the excess KOH and the KOH that was consumed to neutralize the acid groups on the surface of the carbon black. The number of mmol of HCl added between these two inflection points is equivalent to the number of mmol of acid on the pigment. Dividing this number of mmol by the original weight (gram) of the pigment in the titrated sample provides the Acid Value for the pigment in a unit of mmol per gram of pigment.

In Step (b), the product of step (a) is functionalized in an aqueous environment. The product of step (a) is functionalized by oxidation or other chemical reactions to introduce hydrophilic groups comprising carboxylic acid to the pigment surface. The carboxylic acid can attach directly on the pigment surface or on ligands that are covalently attached to the pigment surface. Other chemical reactions to introduce such hydrophilic groups include diazotization, Diels-Alder reaction, etc. that that are commonly known to one skilled in the art.

In another embodiment, Step (b) comprises the steps of:

(i) mixing the product of step (a) with an inorganic base in an aqueous solution: and

(ii) oxidizing in an aqueous environment while simultaneously subjecting the pigment to at least one dispersive mixing operation.

Typical inorganic bases in Step (i) include monovalent metal hydroxides. Specifically, the inorganic bases include KOH, NaOH and LiOH. The amount of the inorganic bases is dependent on the Acid Value of the carbon black. Typically, enough quantity of an inorganic base is used to bring the pH of the dispersion to the range of 6-9. Organic bases can also be employed. However, these organic bases should not be reactive towards the reagents to be used in Step (ii).

In Step (ii), oxidants or other chemical reagents are used to functionalize the pigment surface. Typical oxidants include ozone, hypohalide acid salts such as sodium hypochloride and potassium hypochloride, hydrogen peroxide, and metal salts of permanganate. The oxidation takes place in an aqueous environment while simultaneously subjecting the pigment to at least one dispersive mixing operation. Other chemical reagents include the ones for diazotization, Diels-Alder reaction, etc. that are commonly known to one skilled in the art.

When ozone is used as an oxidant for Step (ii), it is typical to introduce the ozone in a manner that produces more and smaller bubbles as opposed to fewer and larger bubbles to aid with the agitation and increase process efficiency.

In another embodiment, the inventive process provides that the product from Step (a) is oxidized with ozone in an aqueous environment while maintaining a pH of 6-9 to keep the pigment particles electrostatically dispersed.

The manner of generating ozone for use in the process is not critical. Typically, a commercially available ozone generation equipment is used. Such equipment generates a gas stream containing between 1-20% by weight of ozone, which is sufficient for the inventive Step (ii). Typically, oxygen is the carrier gas for the ozone, but noble gases may also be used. Typically at least 0.2 grams of ozone per gram of pigment is required to sufficiently oxidize the product of Step (a) to a carbon black dispersion suitable for ink-jet application.

Other additives may be used in the reaction mixture besides water, ozone, pigment and base. For example, the addition of hydrogen peroxide has been shown to shorten the cycle time and to decrease the formation of salts which need to be removed in the purification step. In addition, physically adsorbed dispersants or pigment wetting agents may be added to the reaction mixture, if desired. Examples of physically adsorbed dispersants and pigment wetting agents are familiar to those skilled in the art and include structured polymeric dispersants, commercially available random and structured dispersants (e.g., ethylene oxide extended alkyl phenols), the family of dispersants available from BYK Chemie, and the dispersants and wetting agents disclosed in McCutcheon's Emulsifiers and Detergents, published by Manufacturing Confectioners Publishing Company, Glen Rock, N.J.

In Step (ii) of the present invention, it is critical to subject the mixture of water, oxidant and pigment to at least one dispersive mixing step. Most of mixing or stirring applications involve pumping and forcing the mass flow of a liquid, liquid-solid, or liquid-gas mixture. The intensity of mixing can be characterized by the energy input or the effective shear rate. The effective shear rate for mixing usually ranges from 50 to 200 sec⁻¹ (see, for example: James Y. Oldshue, Fluid Mixing Technology, p. 29, 1983) and from 200 to 20,000 sec⁻¹ for dispersive mixing (see, for example: Temple C. Patton, Paint Flow and Pigment Dispersion, p. 356, 1979). Accordingly, the term “dispersive mixing” is used herein to identify a mixing operation that provides an effective shear rate of at least 200 sec⁻¹. Well known devices such as a media mill, hammer mill, Microfluidizer® (from Microfluidics Corp), homogenizer, jet mill, fluid mill and similar high energy dispersing devices can be used in the present invention. Most typically, a Microfluidizer® is used for milling by passing the mixture through a plurality of nozzles within a liquid jet interaction chamber at a liquid pressure of at least 1000 psi (70 kg/cm²).

Typically, the pigment mixture is purified after Step (ii). In the purification procedure, salts are removed from the pigment mixture (referred to herein as “desalination”) and the mixture is filtered. The desalination process is typically performed by an ultra-filtration. At this point, the pigment mixture may be concentrated if desired by removal of some of the water. Prior to purification, it is typical to cease the flow of ozone and to vent the reaction vessel to release any unreacted ozone, unless, of course, the process is being run as a continuous process.

The concentration of pigment that can be used in the process is not particularly critical. Typically, the maximum amount of pigment should not exceed 50% by weight. A pigment concentration of 5-20%, especially about 10% by weight, is typical for process efficiency.

The self-dispersing pigment dispersions produced by the process of the invention are particularly well suited for use in ink-jet inks, paints, and other general coating applications. Generally speaking, ink-jet inks comprise an aqueous vehicle, a colorant and various additives. The additives arc selected to provide the inks with a desired property or effect, such as to adapt the ink to the requirements of a particular ink-jet printer or to provide a balance of light stability, smear resistance, viscosity, surface tension, optical density, or crust resistance, etc. One of the main advantages of using self-dispersing pigments is that the inks have low viscosity which permits the addition of various additives to provide desirable properties to the printed image. For example, it is known from the patent literature that certain types of polymer binders, when added to inkjet inks, can decrease the tendency of the inks to smear when, for example, printed text is struck with an office highlighter; can decrease the tendency of the inks to be washed off during laundering; can increase the adhesion of the inks to hydrophobic surfaces such as office transparencies and vinyl substrates; and can be used to improve the resistance of the printed inks to abrasion. Examples of these polymer binders include polymers from styrene maleic acid anhydride, polyurethane, and those described in EP 0 974 607, U.S. Pat. No. 6,040,358, EP 0 851 014, U.S. Pat. No. 5,912,280 and U.S. Pat. No. 6,005,023. It is typical that the dispersion of the present invention contains one or more polymer binders to provide such useful properties

Jet velocity, separation length of the droplets, drop size, and stream stability are greatly affected by the surface tension and the viscosity of the ink. Ink-jet inks suitable for use with ink-jet printing systems should have a surface tension in the range of 20 dyne/cm to 70 dyne/cm, and more typically, in the range of 30 dyne/cm to 70 dyne/cm. An acceptable viscosity is no greater than 20 cPs, and typically in the range of 1.0 cPs to 10.0 cPs. Surfactants or penetrating agents are commonly used in ink-jet application to alter surface tension as well as maximize penetration of the ink into the print media. Examples of suitable surfactants include ethoxylated acetylene diols (e.g., Surfynols® series commercially available from Air Products), ethoxylated primary (e.g., Neodol® series commercially available from Shell) and secondary (e.g., Tergitol® series commercially available from Union Carbide) alcohols, sulfosuccinates (e.g., Aerosol® series from Cytec), organosilicones (e.g., Silwet® series from Witco) and fluoro surfactants (e.g., Zonyl® series commercially available from DuPont). The dispersion of the present invention may contain other additives that are commonly used in ink-jet inks.

Typically, ink-jet inks have physical properties compatible with a wide range of ejecting conditions, i.e., driving voltage and pulse width for thermal ink-jet printing devices, driving frequency of the piezo element for either a drop-on-demand device or a continuous device, and the shape and size of the nozzle. The inks may be used with a variety of ink-jet printers such as continuous, piezoelectric drop-on-demand and thermal or bubble jet drop-on-demand. The inks should have excellent storage stability for a lone period and do not clog in an ink-jet apparatus. Fixing the inks on the image recording material, such as, paper, fabric, film, etc., can be carried out rapidly and accurately. The printed ink images have clear color tones, high density, excellent water resistance and lightfastness. Furthermore, the inks do not corrode parts of the ink-jet printing device it conies in contact with.

The following examples illustrate the invention without, however, being limited thereto.

### EXAMPLES

Unless otherwise stated, ozone was generated using ozone generator model GL-1 manufactured by PCI-WEDECO using either air or industrial grade oxygen as the feed gas. Particle sizes were determined using a Microtrac® UPA 150 model analyzer manufactured by Honeywell. Viscosity was determined using a Brookfield viscometer with a UL adapter from Brookfield Instruments.

The carbon black pigments listed in Table 1 below were used to prepare Samples A-G. These carbon blacks were obtained from an oxidation of raw carbon black in a gaseous environment, and were supplied by Evonik Degussa Corporation, Parsippany, N.C. Such carbon blacks can generally be made by one of reasonable skill in the art according to the disclosure of U.S. Pat. No. 6,471,763. The properties (Volatiles at 950° C. and Acid Value) of these carbon blacks are also included in Table 1.

TABLE 1

| | | Volatiles at 950° C. | Acid Value |
|---|---|---|---|
| Pigment | Lot # | (%) | (mmol/g) |
| Carbon Black | 1 | 22 | >0.2 |
| Carbon Black | 2 | 17 | >0.2 |
| Carbon Black | 3 | 11 | 0.203 |
| Carbon Black | 4 | 10.2 | 0.130 |
| Carbon Black | 5 | 6.9 | 0.102 |
| Carbon Black | 6 | 5.6 | 0.090 |

### Preparation of Sample A-1

To an High Speed Dispersing (HSD) vessel containing de-ionized water (2,590 grams) and aqueous KOH (6 N, 112 grams) was added a carbon black pigment (Lot 1, 347 grams). The agitator on the HSD was activated and maintained at 1000 RPM for one hour to pre-wet the pigment. The mixture was forced to pass through a M110 Microfluidizer with 75 micron diamond Z chambers 10 times at a pressure of 10,000 psi to reduce particle sizes to 93 nm. The resulting dispersion (2,630 grams) was diluted with additional de-ionized water (1,954 grams), heated to 66° C., ultra-filtrated using a spiral wound column with a setting of 500,000 molecular weight cut-off, and washed with de-ionized water (55,282 grams) to remove impurities that may have been in the dry-oxidized Carbon Black pigment. The wash water was discarded, and additional water from the dispersion was removed to provide an aqueous dispersion with 13.4% of pigment.

### Preparation of Sample A-2

To an HSD vessel containing de-ionized water (254 grams) was added Sample A-1 (746 grams). The agitator on the HSD was activated and maintained at 700 RPM for one hour to pre-wet the pigment, and for another three hours while a dip tube positioned just below the blade of the HSD was used to introduce 6.5% ozone at a rate of 4 liters/minute. During the oxidation, the pH was adjusted to 7.0 on an hourly basis with aqueous KOH (5 N). The resulting dispersion was heated to 66° C., ultra-filtrated using a spiral wound column with a setting of 500,000 molecular weight cut-off, and washed with de-ionized water (11,000 grams). The wash water was discarded, and additional water from the dispersion was removed to provide an aqueous dispersion with 12.4% of pigment.

### Preparation of Sample B-1

To an HSD vessel containing de-ionized water (2,196 grams) and a carbon black pigment (Lot 2, 308 grams) was added aqueous KOH (6 N, 63 grams) to bring the pH to 7.0. The agitator on the HSD was activated and maintained at 1000 RPM for one hour to pre-wet the pigment. The mixture was forced to pass through a M110 Microfluidizer with 75 micron diamond Z chambers 10 times at a pressure of 10,000 psi to reduce particle sizes to 101 nm. The resulting dispersion (1,795 grams) was diluted with additional de-ionized water (1,607 grams), heated to 66° C., ultra-filtrated using a spiral wound column with a setting of 500,000 molecular weight cut-off, and washed with de-ionized water (37,246 grams) to remove impurities that may have been in the dry-oxidized Carbon Black pigment. The wash water was discarded, and additional water from the dispersion was removed to provide an aqueous dispersion with 12.8% of pigment.

### Preparation of Sample B-2

To an HSD vessel containing de-ionized water (219 grams) was added Sample B-1 (781 grams). The agitator on the HSD was activated and maintained at 700 RPM for one hour to pre-wet the pigment, and for another three hours while a dip tube positioned just below the blade of the HSD was used to introduce 6.5% ozone at a rate of 4 liters/minute. During the oxidation, the pH was adjusted to 7.0 on an hourly basis with aqueous KOH (5 N). The resulting dispersion was heated to 66° C., ultra-filtrated using a spiral wound column with a setting of 500,000 molecular weight cut-off, and washed with de-ionized water (8,000 grams). The wash water was discarded, and additional water from the dispersion was removed to provide an aqueous dispersion with 12.4% of pigment.

### Preparation of Sample C-1

To an HSD vessel containing de-ionized water (2,247 grams) and a carbon black pigment (Lot 3, 308 grams) was added aqueous KOH (6 N, 12.4 grams) to bring the pH to 7.0. The agitator on the HSD was activated and maintained at 1000 RPM for one hour to pre-wet the pigment. The mixture was forced to pass through a M110 Microfluidizer with 75 micron diamond Z chambers 10 times at a pressure of 10,000 psi to reduce particle sizes to 120 nm. The resulting dispersion (1,961 grams) was diluted with additional de-ionized water (1,547 grams), heated to 66° C., ultra-filtrated using a spiral wound column with a setting of 500,000 molecular weight cut-off, and washed with de-ionized water (18,622 grams) to remove impurities that may have been in the dry-oxidized Carbon Black pigment. The wash water was discarded, and additional water from the dispersion was removed to provide an aqueous dispersion with 12.1% of pigment.

### Preparation of Sample C-2

To an HSD vessel containing de-ionized water (173 grams) was added Sample C-1 (819 grams). The agitator on the HSD was activated and maintained at 700 RPM for one hour to pre-wet the pigment, and for another three hours while a dip tube positioned just below the blade of the HSD was used to introduce 6.5% ozone at a rate of 4 liters/minute. During the oxidation, the pH was adjusted to 7.0 on an hourly basis with aqueous KOH. (5 N). The resulting dispersion was heated to 66° C., ultra-filtrated using a spiral wound column with a setting of 500,000 molecular weight cut-off, and washed with de-ionized water (7,000 grams). The wash water was discarded, and additional water from the dispersion was removed to provide an aqueous dispersion with 12.4% of pigment.

### Preparation of Sample D

To an HSD vessel containing de-ionized water (2,640 grams) and a carbon black pigment (Lot 4, 360 grams) was added aqueous KOH (6 N, 8.0 grams) to bring the pH to 7.0. The agitator on the HSD was activated and maintained at 700 RPM for one hour to pre-wet the pigment. To the dispersion was introduced 6.5% ozone at a rate of 4 liters/minute via a dip tube positioned just below the blade of the HSD for a period of 8 hours. During the oxidation, the dispersion was subjected to a grinding operation in a recycle mode through a M110 Microfluidizer with 75 micron diamond Z chambers at a pressure of 10,000 psi, and the pH was adjusted to 7.0 on an hourly basis with aqueous KOH (5 N). The median particle size decreased to 83 nm when the grinding operation was completed and the Microfluidizer was shut off. Ozone was allowed to flow through the mixture for an additional hour with the agitator on the HSD rotating. The resulting dispersion (2,547 grams) was diluted with de-ionized water (1,944 grams), and the mixture was heated to 66° C., ultra-filtrated using a spiral wound column with a setting of 500,000 molecular weight cut-off, and washed with de-ionized water (26,093 grams) to remove impurities that may have been in the dry-oxidized Carbon Black pigment. The wash water was discarded, and additional water from the dispersion was removed to provide an aqueous dispersion with 12.7% or pigment.

### Preparation of Sample E

To an HSD vessel containing de-ionized water (2,640 grams) and a carbon black pigment (Lot 5, 360 grams) was added aqueous KOH (6 N, 6.0 grams) to bring the pH to 7.0. The agitator on the HSD was activated and maintained at 700 RPM for one hour to pre-wet the pigment. To the dispersion was introduced 6.5% ozone at a rate of 4 liters/minute via a dip tube positioned just below the blade of the HSD for a period of 8 hours. During the oxidation, the dispersion was subjected to a grinding operation in a recycle mode through a M110 Microfluidizer with 75 micron diamond Z chambers at a pressure of 10,000 psi and the pH was adjusted to 7.0 on an hourly basis with aqueous KOH (5 N). The median particle size decreased to 85 nm when the grinding operation was completed and the Microfluidizer was shut off. Ozone was allowed to continue to flow through the mixture for an additional hour with the agitator on the HSD rotating. Modest amount of clogging of the chambers of the Microfluidizer was observed, but the grinding operation was able to continue until completion. The resulting dispersion (2,493 grams) was diluted with de-ionized water (1,553 grams), and the mixture was heated to 66° C., ultra-filtrated using a spiral wound column with a setting of 500,000 molecular weight cut-off, and washed with de-ionized water (27,090 grams) to remove impurities that may have been in the dry-oxidized Carbon Black pigment. The wash water was discarded, and additional water from the dispersion was removed to provide an aqueous dispersion with 13.2% of pigment.

### Preparation of Sample F

To an HSD vessel containing de-ionized water (2,640 grams) and a carbon black pigment (Lot 6, 360 grams) was added aqueous KOH (6 N, 3.5 grams) to bring the pH to 7.0. The agitator on the HSD was activated and maintained at 700 RPM for one hour to pre-wet the pigment. To the dispersion was introduced 6.5% ozone at a rate of 4 liters/minute via a dip tube positioned just below the blade of the HSD while the dispersion was simultaneously subjected to a grinding operation in a recycle mode through a M110 Microfluidizer with 75 micron diamond Z chambers at a pressure of 10,000. The pH was maintained at 7.0. Severe clogging of the Microfluidizer chambers quickly developed, and the run was aborted. This indicated that the pigment could not be adequately dispersed to a size suitable for an inkjet application.

### Preparation of Sample G

To an HSD vessel containing de-ionized water (2,628 grams) and a carbon black pigment (Lot 3, 360 grams) was added aqueous KOH (6 N, 12.3 grams) to bring the pH to 7.0. The agitator on the HSD was activated and maintained at 700 RPM for one hour to pre-wet the pigment. To the dispersion was introduced 6.5% ozone at a rate of 4 liters/minute via a dip tube positioned just below the blade of the HSD for a period of 8 hours. During the oxidation, the dispersion was subjected to a grinding operation in a recycle mode through a M110 Microfluidizer with 75 micron diamond Z chambers at a pressure of 10,000 psi and the pH was adjusted to 7.0 on an hourly basis with aqueous KOH (5 N). The median particle size decreased to 83 nm when the grinding operation was completed and the Microfluidizer was shut off. Ozone was allowed to continue to flow through the mixture for an additional hour with the agitator on the HSD rotating. The resulting dispersion (2,604 grams) was diluted with de-ionized water (2,010 grams), and the mixture was heated to 66° C., ultra-Filtrated using a spiral wound column with a setting of 500,000 molecular weight cut-off, and washed with de-ionized water (36,413 grams) to remove impurities that may have been in the dry-oxidized Carbon Black pigment. The wash water was discarded, and additional water from the dispersion was removed to provide an aqueous dispersion with 13.2% of pigment.

### Preparation of Sample H

To an HSD vessel containing de-ionized water (2,628 grams) and a carbon black pigment (Lot 3, 360 grams) was added aqueous KOH (6 N. 12.3 grams) to bring the pH to 7.0. The agitator on the HSD was activated and maintained at 700 RPM for one hour to pre-wet the pigment. The dispersion was subjected to a grinding operation in a recycle mode through a M110 Microfluidizer with 75 micron diamond Z chambers at a pressure of 10,000 psi for 4 hours. To the dispersion was introduced 6.5% ozone at a rate of 4 liters/minute via a dip tube positioned just below the blade of the HSD for a period of 4 hours. During the oxidation, the dispersion was subjected to a grinding operation in a recycle mode through a M110 Microfluidizer with 75 micron diamond Z chambers at a pressure of 10,000 psi and the pH was adjusted to 7.0 on an hourly basis with aqueous KOH (5 N). The median particle size decreased to 96 nm when the grinding operation was completed and the Microfluidizer was shut off. Ozone was allowed to continue to flow through the mixture for an additional hour with the agitator on the HSD rotating. The resulting dispersion (2,827 grams) was diluted with de-ionized water (2,230 grams), and the mixture was heated to 66° C., ultra-filtrated using a spiral wound column with a setting of 500,000 molecular weight cut-off, and washed with de-ionized water (36,413 grams) to remove impurities that may have been in the dry-oxidized Carbon Black pigment. The wash water was discarded, and additional water from the dispersion was removed to provide an aqueous dispersion with 12.1% of pigment.

### Preparation of Sample I

To an HSD vessel containing de-ionized water (2,628 grams) and a carbon black pigment (Lot 3, 360 grams) was added aqueous KOH (6 N, 12.3 grams) to bring the pH to 7.0. The agitator on the HSD was activated and maintained at 700 RPM for one hour to pre-wet the pigment. The dispersion was subjected to a grinding operation in a recycle mode through a M110 Microfluidizer with 75 micron diamond Z chambers at a pressure of 10,000 psi for 7 hours. To the dispersion was introduced 6.5% ozone at a rate of 4 liters/minute via a dip tube positioned just below the blade of the HSD for one hour. During the oxidation, the dispersion was subjected to a grinding operation in a recycle mode through a M110 Microfluidizer with 75 micron diamond Z chambers at a pressure of 10,000 psi and the pH was adjusted to 7.0 on an hourly basis with aqueous KOH (5 N). The median particle size decreased to 91 nm when the grinding operation was completed and the Microfluidizer was shut off. Ozone was allowed to continue to flow through the mixture for an additional hour with the agitator on the HSD rotating. The resulting dispersion (2,245 grams) was diluted with de-ionized water (1,654 grams), and the mixture was heated to 66° C., ultra-filtrated using a spiral wound column with a setting of 500,000 molecular weight cut-off, and washed with de-ionized water (16,180 grams) to remove impurities that may have been in the dry-oxidized Carbon Black pigment. The wash water was discarded, and additional water from the dispersion was removed to provide an aqueous dispersion with 14.7% of pigment.

### Example 1

As shown in Table 2, Samples A-D and G-I were successfully prepared using Lots 1-4 of Carbon Black with Acid Value greater than 0.1 mmol/g. Modest clogging of equipment was encountered during the preparation of Sample E. The preparation of Sample F failed due to high viscosity of the dispersion as a result of low Acid Value of the Carbon Black used. These results demonstrate that the Acid Value for carbon black pigment after the inventive Step (a) should be greater than 0.1 mmol/g.

TABLE 2

| | | Acid Value | | |
|---|---|---|---|---|
| Pigment | Lot # | (mmol/g) | Sample | Processibility |
| Carbon Black | 1 | >0.2 | A-1 | Excellent |
| Carbon Black | 2 | >0.2 | B-1 | Excellent |
| Carbon Black | 3 | 0.203 | C-1, G, H, I | Excellent |
| Carbon Black | 4 | 0.130 | D | Excellent |
| Carbon Black | 5 | 0.102 | E | Good |
| Carbon Black | 6 | 0.090 | F | Failed |

### Example 2

Samples A-H were subjected to an aging test in an oven set at 70° C. for one week. The viscosity and D50 for each sample were measured and listed in Table 3. The results summarized in Table 3 show that dry oxidation and purification alone (Samples A-1, B-1 and C-1) produced pigment dispersions of inferior quality. Samples A-1 and B-1 showed increases both in viscosity and particle size after the aging test. Although C-1 has acceptable particle size increase after the aging test, its initial particle size is too high (>10 nm). Also inferior is dry oxidation followed by wet oxidation without a dispersive mixing operation (Samples A-2, B-2 and C-2). Oxidation with ozone in an aqueous environment while simultaneously grinding (dispersive mixing) the dispersion provided dispersions (Samples G and H) having the properties of low particle size (<110 nm), stable particle size (% Increase in D50 <10%) and stable viscosity (% Increase in Viscosity<10%) suitable for ink-jet application. Sample I was prepared with insufficient oxidation although accompanied by adequate grinding (dispersing mixing). As shown in Table 3, Sample I was found to be an unstable pigment dispersion due to increases in viscosity and particle size during the aging test.

TABLE 3

| | | Viscosity After 1 | | | D50 After 1 | |
|---|---|---|---|---|---|---|
| | Initial | Week at 70° C. | % Increase in | Initial D50 | Week at 70° C. | % Increase |
| Sample | Viscosity (cPs) | (cPs) | Viscosity | (nm) | (nm) | in D50 |
| A-1 | 2.57 | >500 | >500% | 99 | 153.80 | 55% |
| B-1 | 2.59 | >500 | >500% | 104 | 177.20 | 71% |
| C-1 | 4.82 | 5.43 | 13% | 127 | 132.50 | 4% |
| A-2 | 3.38 | 6.73 | 99% | 97 | 120.50 | 24% |
| B-2 | 2.86 | 7.42 | 159% | 105 | 128.20 | 22% |
| C-2 | 3.62 | 3.29 | −9% | 112 | 110.00 | −2% |
| G (8 hours Ozone | 3.34 | 2.74 | −18% | 101 | 96 | −5% |
| During Grind) | | | | | | |
| H (4 hours Ozone | 2.82 | 2.47 | −12% | 98 | 87.8 | −11% |
| During Grind) | | | | | | |
| I (1 hour Ozone | 3.15 | 5.25 | 67% | 99 | 121.7 | 23% |
| During Grind) | | | | | | |

### Example 3

To test the pen reliability of the inventive pigment dispersion, Inks 1A-1C were prepared using Samples G-I and other ingredients listed in Table 4 below.

TABLE 4

| Ingredients | Ink 1A | Ink 1B | Ink 1C |
|---|---|---|---|
| Sample G* | 3.0 | — | — |
| Sample H* | — | 3.0 | — |
| Sample I* | — | — | 3.0 |
| 2-Pyrrolidone^{§} | 10.0 | 10.0 | 10.0 |
| Liponics Ethoxylated Glycol^{§} | 4 | 4 | 4 |
| Surfynol ® 465^{§} | 0.2 | 0.2 | 0.2 |
| Proxel ™ GXL^{§} | 0.2 | 0.2 | 0.2 |
| Water Added | Balance | Balance | Balance |
| | to 100% | to 100% | to 100% |

*as % by weight of pure pigment based on the total weight of ink
^{§}as % by weight based on the total weight of ink

Inks 1A-1C were loaded into separate HP45 inkjet cartridges. Electronic signals were sent to the cartridge pen to force it to fire ink droplets from all 22 nozzles at a Firing frequency of 6,038 pulses per second. The duration of each pulse was set at 2.2 microseconds. The average weight of a drop from the pen as a function of the volume of ink dispensed from the pen was calculated by weighing a million drops of ink at a time into a dish mounted on an analytical balance. An ink suitable for an ink-jet application should maintain a stable drop weight of between 20 to 30 nanograms throughout the firing of 20 mL of ink.

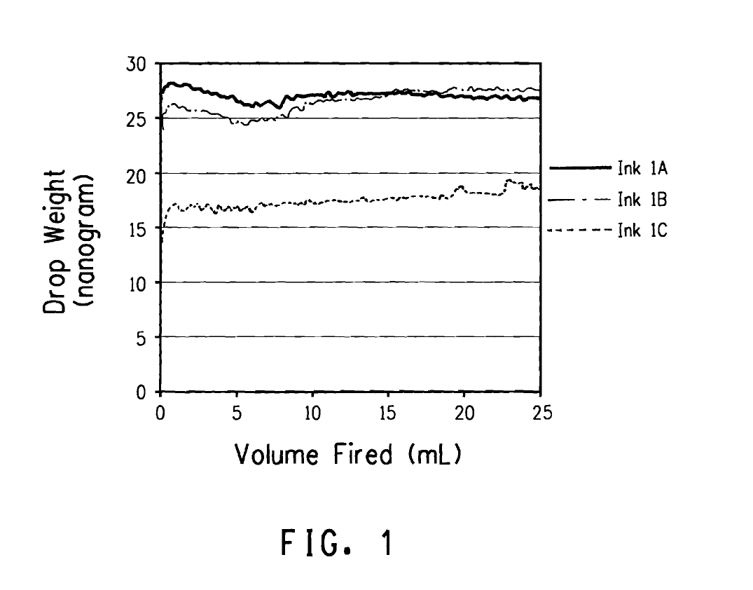

FIG. 1 shows that Inks 1A and 1B obtained from Samples G and H exhibited excellent pen reliability whereas Ink 1C showed poor pen reliability due to low drop weight.

We claim:

1. A process for making a self-dispersing pigment dispersion comprising the steps of:
(a) subjecting a carbon black pigment to oxidation in a gaseous environment to an acid value of greater than 0.1 mmol of acid per gram of pigment; and
(b) functionalizing the product of step (a) in an aqueous environment.

2. The process of claim 1, wherein step (b) introduces ligands containing at least one carboxylic functional group, said ligands are covalently attached to the pigment.

3. The process of claim 1, wherein step (b) comprises the steps of:
(i) mixing the product of step (a) with an inorganic base in an aqueous solution; and
(ii) oxidizing in an aqueous environment while simultaneously subjecting the pigment to at least one dispersive mixing operation.

4. The process of claim 3, wherein the carbon black pigment is present in an amount of up to 50% by weight.

5. The process of claim 4, wherein the carbon. black pigment is present in an amount between 5% and 25% by weight.

6. The process of claim 3, wherein the inorganic base is selected from the group consisting of KOH, NaOH and LiOH.

7. The process of claim 6, wherein the average particle size after step (ii) is between 0.005 microns and 5 microns.

8. The process of claim 7, wherein the average particle size after step (ii) is between 0.01 microns and 0.3 microns.

9. The process of claim 1, wherein the gaseous environment comprises ozone.

10. The process of claim 9, wherein the ozone is 1% to 20% by weight of ozone gas in a carrier gas.

11. The process of claim 3, wherein the aqueous environment for step (ii) comprises an oxidant for functionalizing the pigment.

12. The process of claim 11, wherein the oxidant is selected from the group consisting of ozone, hypohalide salts, hydrogen peroxide, and metal salts of a permanganate.

13. The process of claim 12 wherein the oxidant is ozone.

14. The process of claim 13, wherein the pH of the aqueous environment for step (ii) is in the range of 6 to 9.

15. The process of claim 1, further comprises purifying the self-dispersing pigment dispersion.
